(19) United States
(12) Patent Application Publication
(10) Pub. No.: US 2005/0012940 A1
(43) Pub. Date: Jan. 20, 2005

(54) Image forming apparatus

(75) Inventor: Yoji Matsuda, Mishima-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/889,204

(22) Filed: Jul. 13, 2004

(30) Foreign Application Priority Data
Jul. 17, 2003 (JP) 2003-198592

(51) Int. Cl. G06F 15/00

(52) U.S. Cl. 358/1.1; 358/1.15

(57) ABSTRACT

An input and output environment suited for more various input originals and recording mediums is provided by enabling a plurality of jobs having totally different input conditions and output conditions to be connected. This invention relates to an image forming apparatus including at least one image input section that fetches image data on an original, and at least one image output section printing out the image data. The image forming apparatus includes a job information fetching section for fetching set values as a plurality of different jobs whenever input and output conditions for the image data differ, and for connecting the plurality of different jobs as a series of jobs, and a printout control section for controlling the image output section to execute a series of printout processings according to the output conditions for the respective plurality of jobs connected as the series of jobs.

### BACKGROUND OF THE INVENTION

The present invention relates to an image forming apparatus such as a copying machine, a printer, or a compound machine that functions as a copying machine and a printer. The image forming apparatus according to the present invention enables integrating individual output results and outputting the integrated output result as one job for print jobs such as a copying job for which a plurality of original types, original sizes, input method, output media types, and output formats are present.

Conventionally, several techniques for allowing setting another job while one job operates are proposed.

According to, for example, Japanese Patent Application Laid-Open No. 2001-235976, when a manual feed job is set while a certain job is being executed, a setting of media types (an original type and an original size) in a manual feed tray can be made. According to Japanese Patent Application Laid-Open No. 2002-169685, a technique for integrating a plurality of jobs, and partially performing duplex print is disclosed. According to Japanese Patent Laid-Open No. 2002-108845, a screen display method for clarifying a mutual relation among a plurality of electronic documents when integrating them with one another is disclosed. According to Japanese Patent Laid-Open No. 11-252290, a technique for integrating a plurality of pieces of document data and input image data and outputting the integrated data is disclosed. According to Japanese Patent Laid-Open No. 2001-156984, a technique for integrating a plurality of print documents and displaying contradictory points is disclosed.

According to each of these conventional techniques, however, during a series of processings, a user often continuously uses one input device. No technique for switching various input conditions and various input methods and for handling the processings as a series of jobs, and that for improving image quality and operativity for a print operation for which a media type is switched over to another media type during the operation or for a copying operation for which color/monochrome types, original types, output formats, and output mediums are present have been proposed yet.

Further, even though a technique for integrating jobs having different input conditions is proposed, a technique for dividing jobs to processings including an output processing, and then re-integrating the divided jobs even including switchover of an image processing according to the media type or the original type has not been proposed yet.

Meanwhile, with spread of full-color copying machines, a demand for improving the image quality of the copying machine increasingly expands. At present, therefore, the number of requirements for image attribute parameters and those for output processing formats to be designated for an input original rapidly increases. In one copying operation, it is difficult to provide the copying operation that can satisfy all input image attributes and input method conditions. For instance, if photography-base originals and character-base originals or one-sided originals and double-sided originals are mixed in a series of documents, or originals having dark grounds and originals having white grounds are mixed such as a newspaper, it is difficult to perform an image input operation that satisfy these conditions by one operation.

Furthermore, as output mediums, it is difficult to designate a medium to an OHP sheet, a paperboard, or the like only for output pages of a designated original. Actually, with an increase in the number of color originals and an improvement in image quality, a demand for using a color-dedicated output medium in a designated portion so as to partially incorporate a color picture, or for partially using a paperboard so as to prevent both-sided off-set is increasing.

Moreover, as the output method, it is difficult to perform duplex output or rotating output only for a designated range of the original.

To solve these disadvantages, there is known a method for classifying input images according to input means, output medium, or output modes, performing a copying operation according to their respective attributes, and manually integrating the resultant images after all the operations are finished. This method, however, involves quite complicated labor and long time, so that a throughput of the apparatus is disadvantageously, considerably deteriorated by this method.

### SUMMARY OF THE INVENTION

The present invention provides an input and output environment suited for more various input originals and recording mediums by enabling a plurality of jobs totally different in input conditions and output conditions to be integrated.

According to one aspect of the present invention, there is provided an image forming apparatus including at least one image input section that fetches image data on an original, and at least one image output section printing out the image data, comprising: job information fetching means for fetching set values as a plurality of different jobs whenever input and output conditions for the image data differ, and for connecting the plurality of different jobs as a series of jobs; and printout control means for controlling the image output section to execute a series of printout processings according to the output conditions for the respective plurality of jobs connected as the series of jobs.

According to the one aspect of the present invention, one user intended job can be divided and output into a plurality of types of input jobs, print conditions during output can be designated, and the integrated print processing can be carried out during output. Therefore, for one job intended by the user for which various originals are mixed, the high-quality printout throughput of the apparatus for the job for which the various originals are mixed can be considerably reduced.

Furthermore, another invention according to the present invention has been achieved in view of a need for an output side to integrate pieces of image data from various inputs, which arises with an improvement in flexibility of an input side, and a need of output processings according to image attributes of the image data, and proposes a control method that satisfies the needs.

According to another aspect of the present invention, there is provided an image forming apparatus including at least one image input section that fetches image data of an original, and at least one image output section printing out the image data, comprising: job information fetching means for fetching set values as a plurality of different jobs whenever input and output conditions for the image data differ, and for connecting the plurality of different jobs as a series of jobs; inter-job output condition monitoring means for limiting, among the respective plurality of jobs connected as the series of jobs, the set values of the other jobs contradicting set values of the output conditions for the standard job; and printout control means for controlling the image output section to execute a series of printout processings according to the output conditions for the respective plurality of jobs connected as the series of jobs.

According to another aspect of the present invention, the high-quality printout throughput of the apparatus for the job for which various originals are mixed can be considerably reduced. In addition, by prohibiting settings of the setting conditions contradicting the output conditions designated for the standard job from being changed for the other jobs, the number of output failures caused by print attribute setting errors can be decreased.

### BRIEF DESCRIPTION OF THE DRAWINGS

FIG. 1 is a perspective view which shows an external appearance of a color image forming apparatus according to one embodiment of the present invention;

FIG. 2 shows an example of internal configuration of the color image forming apparatus shown in FIG. 1;

FIG. 3 is a block diagram which shows system configuration of the color image forming apparatus shown in FIG. 1;

FIG. 4 shows an operation panel in the color image forming apparatus shown in FIG. 1;

FIG. 5 is a block diagram which shows configuration of a touch panel display in the operation panel shown in FIG. 4;

FIG. 6 is a block diagram which shows functional configuration of control sections in the color image forming apparatus shown in FIG. 1;

FIG. 7 is a flowchart which shows a flow of overall control related to job connection of the color image forming apparatus shown in FIG. 1;

FIG. 8 shows one example of a menu screen displayed when a job integration processing is selected in the color image forming apparatus shown in FIG. 1;

FIG. 9 is a flowchart which shows procedures for setting jobs related to original input in the color image forming apparatus shown in FIG. 1;

FIG. 10 is a flowchart which shows procedures for setting jobs related to original input in the color image forming apparatus shown in FIG. 1;

FIG. 11 shows a menu screen when the job setting is made in the color image forming apparatus shown in FIG. 1;

FIG. 12 shows one example of a restriction of functions of another job according to a setting content of a leading job in the color image forming apparatus shown in FIG. 1;

FIGS. 13A and 13B show one example of management tables for integrally managing connected job data in the color image forming apparatus shown in FIG. 1;

FIG. 14 is a flowchart which shows control procedures when the connected jobs are printed out in the color image forming apparatus shown in FIG. 1; and

FIGS. 15A and 15B are explanatory views for a method for calculating the total converted number of sheets to be compared with the number of limited sheets related to a finishing function in the color image forming apparatus shown in FIG. 1.

### DETAILED DESCRIPTION OF THE PREFERRED EMBODIMENT

An embodiment of an image forming apparatus according to the present invention will be described hereinafter with reference to the drawings. The present invention will be described hereinafter assuming that the image forming apparatus according to the embodiment is a multifunction color copying apparatus.

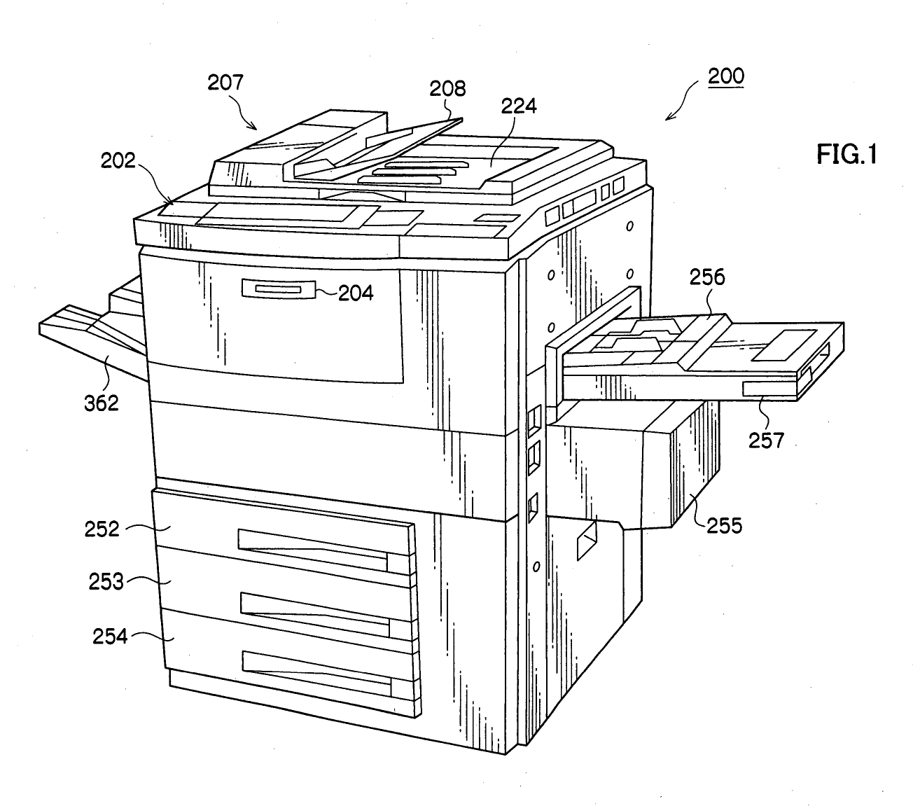

FIG. 1 is a perspective view which shows an external appearance of a color image forming apparatus (multifunction copying apparatus) according to the embodiment of the present invention.

An automatic original feeder (“ADF”) 207 that also serves as an original cover, and that automatically feeds sheet-like originals one by one is provided on the upper portion of an apparatus main body 200 to be freely opened and closed. An operation panel 202 that includes various operation keys, various display units, and the like for designating copying conditions and start of copying is provided in the front portion on an upper surface of the apparatus main body 200. This operation panel 202 will be described later in detail.

A paper feed cassette 257 that can contain a small volume of paper, and a paper feed cassette for a large volume of paper 255 that can contain a large volume of paper are detachably attached respectively at the right side portion of the apparatus main body 200. Incidentally, the paper feed cassette 257 includes a manual feed tray 256 for manually supplying the paper.

Paper feed cassettes 252, 253, and 254 is detachably attached in the lower portion of the apparatus main body 200. Each paper feed cassette 252, 253, and 254 contain the same size paper placed in landscape or portrait orientation, and the paper is selected according to need. A paper discharge tray 362 that receives copied paper is provided at the left side portion of the apparatus main body 200.

An insertion port 204 for inserting a magneto-optical disk serving as a storage medium that stores image data and the like is provided below the operation panel 202 on the front surface of the apparatus main body 200. A magneto-optical disk apparatus (not shown) is provided within the main body 200.

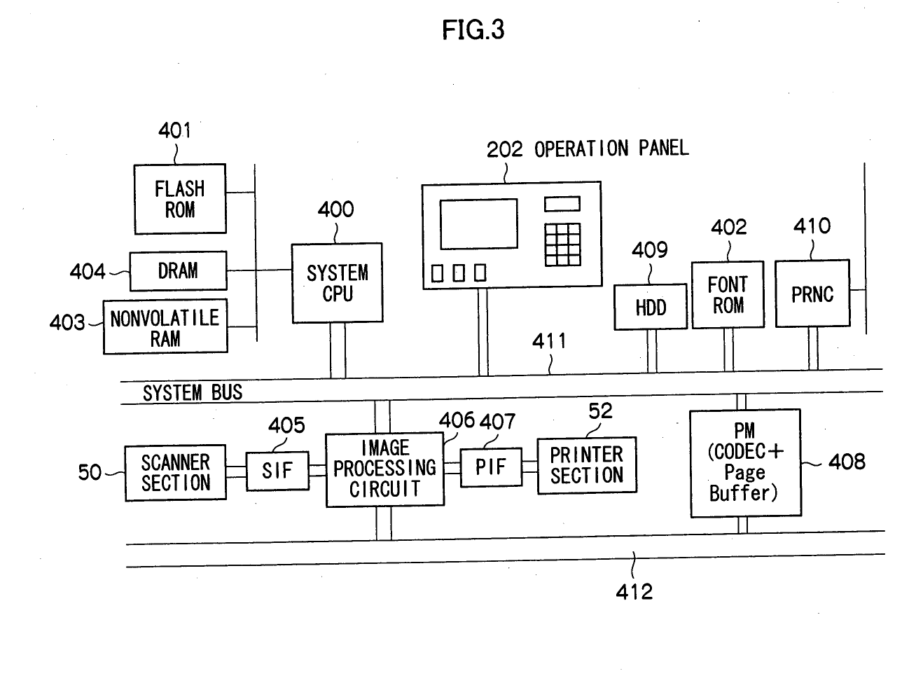

A parallel port (not shown), a serial port (not shown), an SCSI (see FIG. 3), and the like are provided on a rear surface of the apparatus main body 200. The parallel port connects the apparatus to an external apparatus such as a personal computer (“PC”) when the apparatus operates as a printer. The serial port connects the apparatus to the external apparatus such as the PC for reading internal management information on the apparatus and setting functions of the apparatus during maintenance of the apparatus. The SCSI enables holding command/data communication between the apparatus and an external controller that operates as a master.

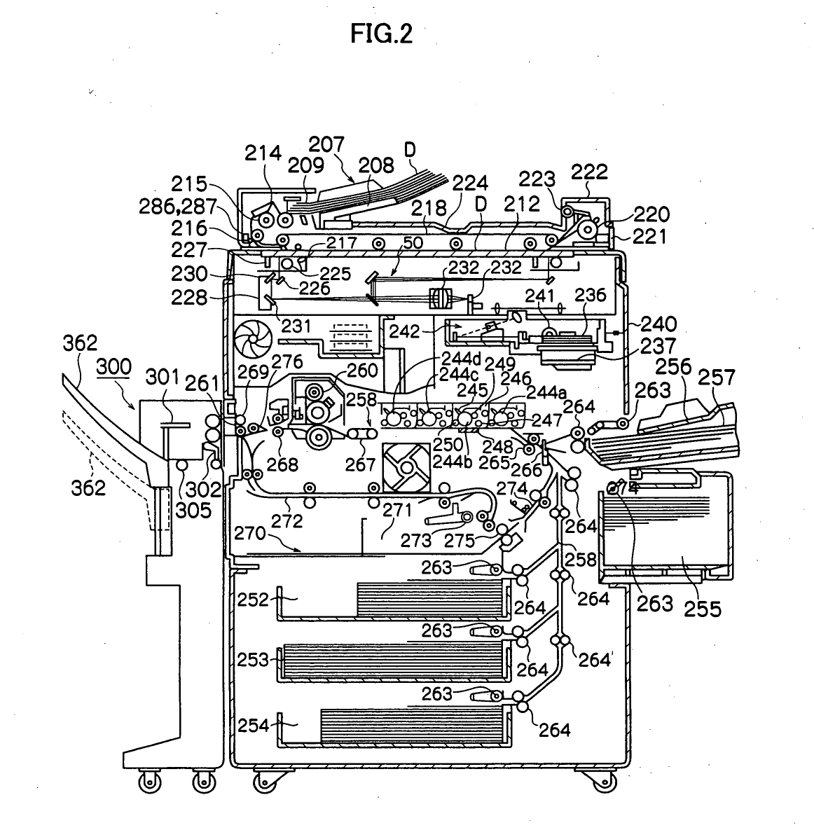

FIG. 2 is a schematic diagram structurally showing an example of internal configuration of the multifunction image forming apparatus shown in FIG. 1.

A scanner section 50 that serves as acquisition means for acquiring image data and a printer section 52 that serves as image forming means if a copying function and a facsimile function are to be realized are provided within the apparatus main body 200.

An original mount 212 on which a read target, that is, an original D is mounted, and which consists of transparent glass, and the ADF 207 that automatically feeds the original on the original mount 212 are provided on the upper surface of the apparatus main body 200. This ADF 207 is provided to be freely opened and closed relative to the original mount 212, and also functions as an original presser that closely attaches the original D mounted on the original mount 212 to the original mount 212.

The ADF 207 includes an original tray 208 in which the original D is set, an empty sensor 209 that detects whether the original is present, a pickup roller 214 that takes out the originals from the original tray 208 one by one, a paper feed roller 215 that carries the originals thus taken out, an aligning roller pair 216 that align tip ends of the respective originals to one another, an aligning sensor 286 that is provided upstream of the aligning roller pair 216 and that detects whether an original arrives, a size sensor 287 that detects a size of the originals D, and a transport belt 218 that is arranged to cover substantially entirely the original mount 212. A plurality of originals set upward in the original tray 208 are taken out in a descending order of pages, that is, taken out sequentially from a final page, aligned by the aligning roller pair 216, and transported to a predetermined position of the original mount 212 by the transport belt 218.

In the ADF 207, a reverse roller 220, a non-reversal sensor 221, a flapper 222, and a paper discharge roller 223 are provided on the end portion opposite to the aligning roller pair 216 across the transport belt 218. The original D image information on which is read by the scanner section 50, to be described later is fed out from onto the original mount 212 by the transport belt 218, and discharged onto an original discharge section 224 provided on the upper surface of the ADF 207 through the reverse roller 220, the flapper 221, and the paper discharge roller 222.

If a rear surface of the original D is to be read, the flapper 222 is switched, whereby the original D transported by the transport belt 218 is reversed by the reverse roller 220 and then fed to the predetermined position on the original mount 212 by the transport belt 218 again.

The ADF 207 includes a paper feed motor (not shown) that drives the pickup roller 214, the paper feed roller 215, and the aligning roller pair 216, and a transport motor (not shown) that drives the transport belt 218, the reverse roller 220, and the paper discharge roller 223.

The scanner section 50 provided within the apparatus main body 200 includes a light source 225, such as a fluorescent lamp, for illuminating the original D mounted on the original mount 212, and a first mirror 226 that deflects a reflected light from the original D in a predetermined direction. The light source 225 and the first mirror 226 are attached to a first carriage 227 provided below the original mount 212. A size sensor 217 that detects the size of the original mounted on the original mount 212 is attached onto this first carriage 227. The first carriage 227 is provided to be movable in parallel to the original mount 212, and is reciprocated downward of the original mount 212 by the drive motor through a toothed belt or the like which is not shown.

Further, a second carriage 228 that can be moved in parallel to the original mount 212 is provided below the original mount 212. A second mirror 230 and a third mirror 231 that sequentially deflect the reflected light from the original D that has been deflected by the first mirror 226 are attached to the second carriage 228 so that deflection angles of the second and the third mirrors 230 and 231 are at a right angle against each other. The second carriage 228 is driven relative to the first carriage 227 by the toothed belt or the like that drives the first carriage 227, and moved in parallel and along the original mount 212 at half a speed of that of the first carriage 227.

An imaging lens 232 that converges the reflected light from the third mirror 231 on the second carriage 228 and a CCD sensor 234 that receives the reflected light converged by the imaging lens 232, and that performs photoelectric conversion are provided below the original mount 212. The imaging lens 232 is provided to be movable into a plane including a light axis of the light deflected by the third mirror 231 through a drive mechanism. The imaging lens 232 images the reflected light at a desired magnification by its movement. The CCD sensor 234 converts the incident reflected light into an electric signal, and outputs the electric signal corresponding to the read original D.

The printer section 52 includes a laser exposure apparatus 240 that functions as exposure means. The laser exposure apparatus 240 includes a semiconductor laser 241 serving as a laser light source, a polygon mirror 236 serving as a scanning member that continuously deflects laser lights emitted from the semiconductor laser 241, a polygon motor 237 serving as a scanning motor that drives the polygon mirror 236 to rotate at a predetermined number of revolutions to be described later, and an optical system 242 that deflects the laser lights from the polygon mirror 236, and that introduces the deflected laser lights to a photosensitive drum to be described later. The laser exposure apparatus 240 thus constituted is fixed to and supported by a support frame, to be described later, of the apparatus main body 200.

The semiconductor laser 241 is controlled to be turned on and off according to the image information on the original D read by the scanner section 50. The laser lights emitted from the semiconductor laser 241 are directed to photosensitive drums 244a to 244d, respectively, through the polygon mirror 236 and the optical system 242. Peripheral surfaces of the respective photosensitive drums 244a to 244d are scanned relative to the laser lights, thereby forming electrostatic latent images on the peripheral surfaces of the respective photosensitive drums 244a to 244d. In FIG. 2, the laser exposure apparatus 240 common to respective color components is shown. Alternatively, laser exposure apparatuses 240 may be provided separately for the respective color components.

The image forming section 52 includes the photosensitive drums 244a to 244d that are provided substantially at a center of the apparatus main body 200, and that are rotatable as image carriers. Desired electrostatic latent images exposed by the laser lights from the laser exposure apparatus 240 are formed on the peripheral surfaces of the respective photosensitive drums 244a to 244d.

An electrostatic charge charger 245 that charges the peripheral surface with predetermined charges, a developer 246 that supplies a toner serving as a developing agent to the electrostatic latent image formed on the peripheral surface and that develops the electrostatic latent image at a desired image density, a separation charger 247 that separates a transfer target material fed from a paper feed cassette 252, 253, 254, 255, 257, or the like, that is, a copy paper P from the photosensitive drum, a transfer charger 248 that transfers a toner image formed on the photosensitive drum to the copy paper P, a separation claw 249 that separates the copy paper P from the peripheral surface, a cleaner 250 that cleans up a residual toner on the peripheral surface, and a charge neutralizer (not shown) that neutralizes the peripheral surface are arranged on the peripheral surface of each of the photosensitive drums 244a to 244d in this order.

The paper feed cassettes 252, 253, and 254 that can be drawn out from the apparatus main body 200 are arranged in the lower portion within the apparatus main body in a stacked state. Sheets of copy paper having different sizes are contained in the respective cassettes 252, 253, and 254. A paper feed cassette for a large volume of paper 255 is provided sideways of these cassettes 252, 253, and 254. Sheets of copy paper having a frequently used size, e.g., about 3,000 sheets of A4-size copy paper are contained in the paper feed cassette for a large volume of paper 255. Further, a paper feed cassette 257 also serving as a manual feed tray 256 is detachably attached upward of the paper feed cassette for a large volume of paper 255.

A transport pathway 258 that extends from each cassette through a transfer section located between the photosensitive drums 244a to 244d and the transfer charger 248 is formed within the apparatus main body 200. A fixing device 260 is provided on a terminal end of the transport pathway 258. A discharge port 261 is formed on a sidewall of the apparatus main body 200 opposed to the fixing device 260, and a finisher 300 is attached to the discharge port 261.

Pickup rollers 263 each of which takes out sheets from the paper feed cassettes 252, 253, 254, 255, and 257 one by one are provided near the cassettes 252, 253, 254, 255, and 257, respectively. Many paper feed roller pairs 264 for transporting the sheets of copy paper P taken out by the pickup rollers 263 via the transport pathway 258 are provided on the transport pathway 258.

On the transport pathway 258, a resist roller pair 265 are provided upstream of the photosensitive drums 244a to 244d. The resist roller pair 265 corrects an inclination of each taken-out copy paper P, aligns tip ends of the toner images formed on the photosensitive drums 244a to 244d to a tip end of the each copy paper P, and feed the copy paper P to the transfer section at a same speed as a moving speed of the peripheral surfaces of the photosensitive drums 244a to 244d. An aligning sensor 266 that detects whether the copy paper P arrives is provided in front of the resist roller pair 265, that is, on a paper feed roller 264 side.

The sheets of copy paper P taken out from the respective cassettes one by one by the pickup roller 263 is fed to the resist roller pair 265 from the paper feed roller pair 264. The tip end of each copy paper P is aligned by the resist roller pair 265, and then the copy paper P is fed to the transfer section.

In the transfer section, the developing agent images, i.e., the toner images formed on the respective photosensitive drums 244a to 244d are transferred onto the paper P by the transfer charger 248. The copy paper P onto which the toner images are transferred is separated from the peripheral surface of each of the photosensitive drums 244a to 244d by functions of the separation charger 247 and the separation claw 249, and transported to the fixing device 260 through a transport belt 267 that constitutes a part of the transport pathway 258. After the developed image is fused and fixed onto the copy paper P by the fixing device 260, the copy paper P is discharged to a discharge tray 362 provided in the finisher 300 through the discharge port 261 by the paper feed roller pair 268 and a paper discharge roller pair 269.

An automatic duplex device (“ADD”) 270 that reverses the copy paper P passed through the fixing device 260 and that feeds the copy paper P to the resist roller pair 265 again is provided below the transport pathway 258. The ADD 270 includes a temporary collecting section 271 that temporarily collects the sheets of copy paper P, a reversal pathway 272 that is branched from the transport pathway 258, reverses the copy paper P passed through the fixing device 260 and introduces the copy paper P to the temporary collecting section 271, a pickup roller 273 that takes out the sheets of copy paper P collected in the temporary collecting section 271 one by one, and a paper feed roller 275 that feeds the sheets thus taken out to the resist roller pair 265 through the transport pathway 274. Further, a sorting gate 276 that selectively sorts the sheets of copy paper P to the discharge port 261 or the reversal path 272 is provided in a branch portion between the transport pathway 258 and the reversal pathway 272.

If duplex copying is performed, the copy paper P passed through the fixing device 260 is introduced to the reversal pathway 272 by the sorting gate 276, temporarily collected in the temporary collecting section 271 in a reversal state, and then fed to the resist roller pair 265 through the transport pathway 274 by the pickup roller 273 and the paper feed roller pair 275. The tip end of the copy paper P is aligned by the resist roller pair 265, the copy paper P is fed again to the transfer section, and a toner image is transferred onto the rear surface of the copy paper P. Thereafter, the copy paper P is discharged into the paper discharge tray 362 in the finisher 300 through the transport pathway 258, the fixing device 260, and the paper discharge roller 269.

In addition, using this ADD 270, the paper can be discharged with the image-printed surface put downward. Namely, similarly to the duplex copying, an image is transferred and fixed onto the surface of the paper, the paper is temporarily collected in the temporary collecting section 271, and passed through the pickup roller 273 and the paper feed roller pair 275 through the transport pathway 274, the tip end of the paper is aligned by the resist roller pair 265, and the paper is discharged into the paper discharge tray 362 through the transport pathway 258, the fixing device 260, and the paper discharge roller 269.

The finisher 300 includes a roller 305 that abuts a rear end of the discharged paper P against a back wall to thereby align the paper P, a paper presser 30 that presses a plurality of discharged sheets of paper P, and an execution mechanism 302 that executes finishing items such as stapling, saddle stitching, or hole punching.

FIG. 3 is a block diagram which shows configuration of a control system in the multifunction image forming apparatus according to this embodiment.

The image forming apparatus includes a system CPU 400, a flash ROM 401 for storing programs and fixed data, a font ROM 402 for converting text data into font data, a nonvolatile RAM (“NVRAM”) 403 for operation and data storage, and a DRAM 404.

The CPU 400 controls entirety of the present apparatus. In this embodiment, the CPU 400 controls respective functions in accordance with an instruction signal from the operation panel 202, a signal input from a communication line, and signals input from various external interfaces.

A scanner interface (“SIF”) 405 receives image data from the scanner section 50. An image processing circuit 406 carries out image editing processings such as an image quality improving processing, an enlargement/reduction processing, a pixel thinning processing, and a transposition reverse processing to a designate region by marker detection. A printer interface (“PIF”) 407 transmits the image data to the printer section 52. A page memory (PM) 408 stores the image data processed by the image processing circuit 406 and waiting for output in units of pages, and includes therein a codec that performs compression and expansion.

The respective devices related to these image signal processings are connected to one another through an image bus 412, and control signals are exchanged between the CPU 400 and the respective devices by a system bus 411 at a high speed.

The image bus 412 is a characteristic bus provided so that the apparatus operates as the copying machine. In order to guarantee a real-time operation of the copying machine, operations for allowing the image data input from the scanner section 50 to be received by the SIF 405, subjected to various editing processings such as the image quality improving processing and the enlargement/reduction processing by the image processing circuit 406, and output to the printer section 52 by the PIF 407, are carried out in parallel (which operations will be generically referred to as “basic copying”). Among boards connected to the image bus 412, boards unnecessary for the respective operations are set in passed states.

Amass storage device (e.g., HDD) 409 stores the image data applied from external apparatuses, image data on printing of a plurality of sheets of paper from the scanner section 50, and the like.

A printer network controller (“PRNC”) 410 includes an interface with the printer section 52 for controlling the copying operation and the image forming function when the apparatus operates as the printer. In addition, the PRNC 410, which is connected to a LAN through a built-in device such as a network interface card, exercises a protocol control and data transfer/compression/expansion controls for receiving print data from a device such as an external PC through the LAN, buffering the data, and transferring the data toward the printer 52.

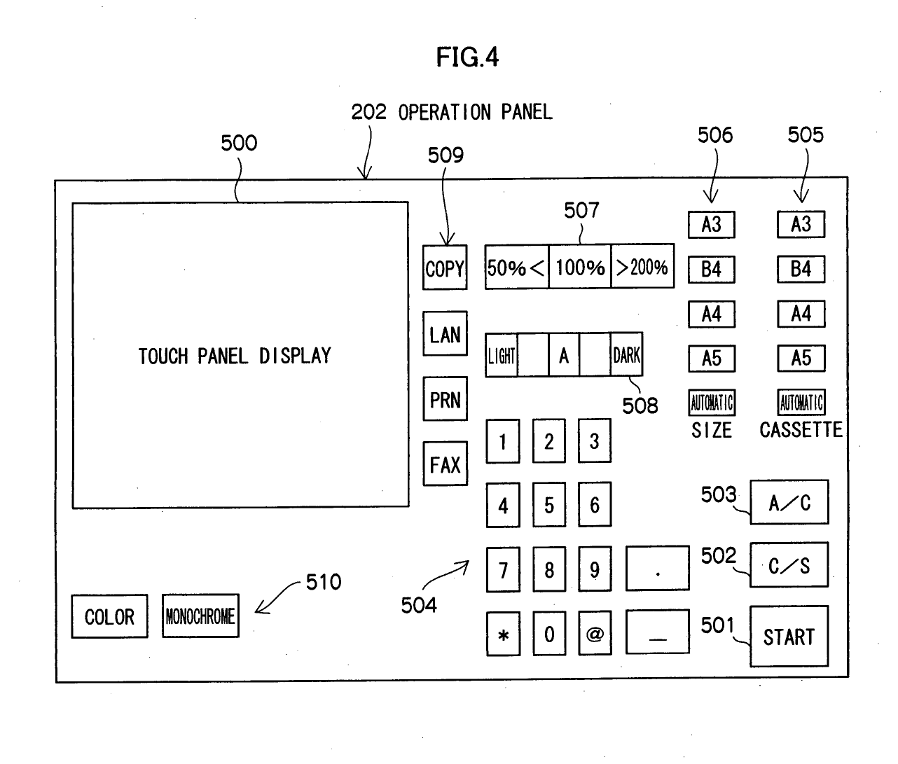

FIG. 4 shows a configuration example of the operation panel 202.

The operation panel 202 includes a touch panel display 500, a start key 501, a stop key 502, a clear key 503, ten keys 504 for setting numbers, a key 505 including therein an light emitting device (LED) for selecting the original size and the cassette, a key 506 including therein an LED for selecting the paper size, a copy magnification setting key 507, a print density setting key 508, an image mode select key 509, a color/monochrome setting key 510, and the like.

The ten keys 504 are arranged similarly to ten keys arranged on a push-button telephone so as to be able to be shared between the copying function and the facsimile function.

For example, if five copies are to be produced, a menu on the touch panel display 500 is switched to ‘COPY’, a desired processing (e.g., duplex copying) is selected, and key “5”, in the ten keys is depressed. If so, this number is displayed in a specific area on the touch panel display 500. After a user's confirmation of the display, the user sets the original and depresses the start key 501, thereby starting the copying operation.

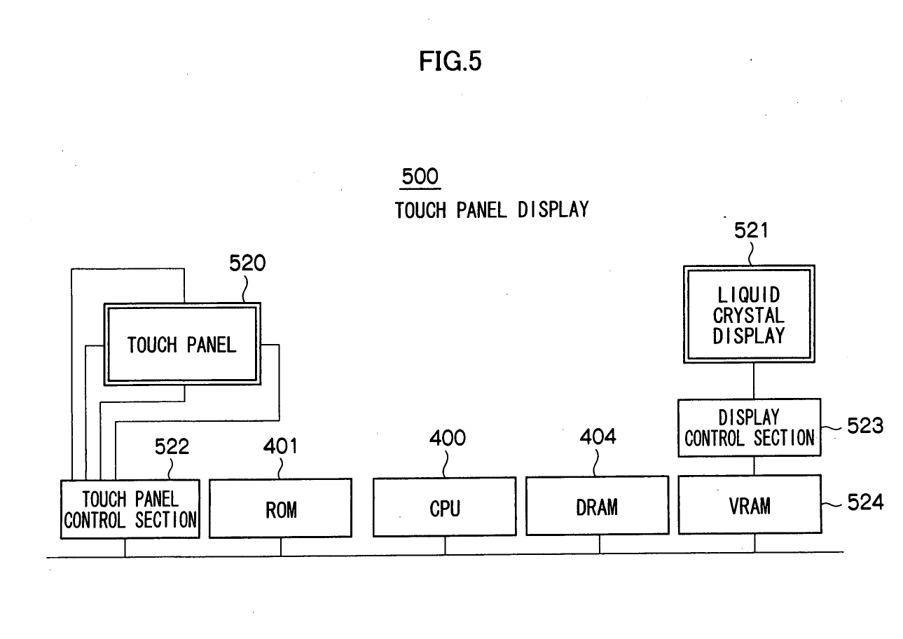

FIG. 5 is a block diagram which shows configuration of the touch panel display 500.

The touch panel display 500 is constituted so that a touch panel 520 is superposed on a liquid crystal display 521. In the touch panel 520, a transparent resistor is uniformly coated on a transparent substrate, and transparent electrodes are arranged in parallel at predetermined intervals in both X and Y directions. Under control of a touch panel control section 522, the respective transparent electrodes in the X and Y directions of the touch panel 520 are sequentially applied with voltages in constant directions. A position instruction operation to the touch panel 520 is carried out using a dedicated conductive pen or a user's finger. The touch panel control section 522 monitors resistances between the electrodes in the X and Y directions, and detects a position at which the resistance is locally reduced in accordance with the instruction using the conductive pen or the user's finger by calculation based on resistances between the electrodes.

A display control section 523 that drives the liquid crystal display 521 to display is connected to the liquid crystal display 521. A video RAM (“VRAM”) 524 that stores display data in units of display pixels is connected to the display control section 522.

In the touch panel display 500 constituted as stated above, the CPU 400 (see FIG. 3) included in a main control section reads position data obtained by the touch panel control section 522, and executes a processing corresponding to this position data. If manuscript input is to be carried out, for example, the CPU 400 executes a keyboard display processing. Specifically, the data in the VRAM 524 corresponding to the position indicated on the touch panel 520 is reversed from a non-display state to a display state, and the data is displayed on the liquid crystal display 521. Further, an operation parameter is input by selecting a key board display displayed on the liquid crystal display 521 and one button from among various setting buttons. As can be seen, this touch panel display 500 can be used for purposes in a wide range.

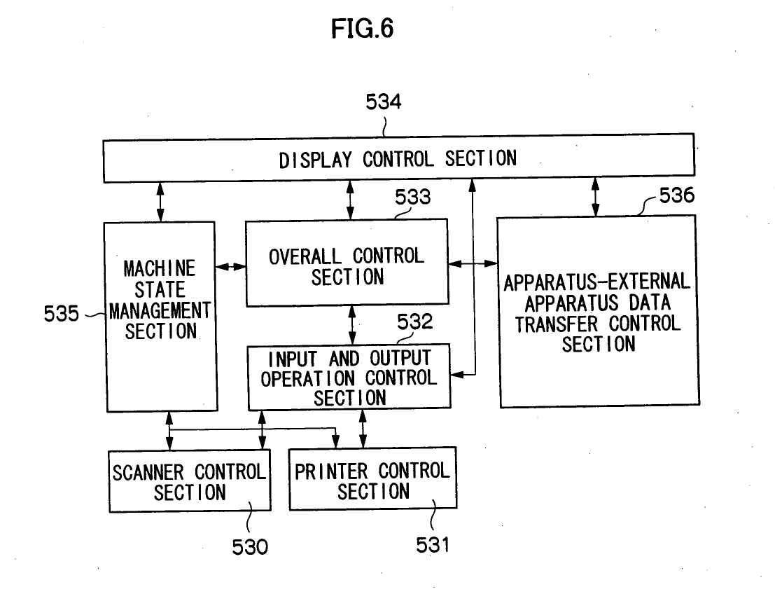

FIG. 6 is a block diagram which shows functional configuration of control sections in the color image forming apparatus according to this embodiment. The control sections correspond to the control sections and the like such as the programs and fixed data stored in the ROM 401, the CPU 400 that execute the programs and the like, and the touch panel control section 522. Functionally, the control sections can be showed by FIG. 6.

A scanner control section 530 corresponds to a scanner control ASIC, scanner control firmware that conducts a scanner drive control and an ADF control when an image is input, and an image processing unit for preprocessing that conducts a shading correction, that are mounted in the scanner section 50 and the like.

A printer control section 531 corresponds to a printer control ASIC, an output-side image processing ASIC, a printer operation control firmware that conducts a printer control and a paper transport control during printing, and a printer-side image processing firmware, that are mounted in the printer section 52. The printer control section 531 includes an interface between the apparatus and a printer driver such as the PC. Using the interface, the printer control section 531 holds a command-status communication with the printer driver for receiving and transmitting a control command and a status signal, respectively, and control a print data communication. The printer control section 531 also controls execution of both printout of the image data input from the scanner section 50 and output of the image data transmitted from the printer driver.

Each of the scanner control section 530 and the printer control section 531 includes its own control CPU and realizes high-speed control. Each of the control CPU's holds a command-status communication with the system CPU 400 shown in FIG. 3, controls synchronized operations of the display, the scanner, and the printer, or the like, and realizes the copying operation and the printout operation to be carried out by the overall apparatus.

An input and output operation control section 532 includes an image processing unit and an interface with the scanner control section 530 and the printer control section 531. an operation start instruction received by an overall control section 33 and the like triggers the input and output operation control section 532, to exercise a timing control for driving the scanner section 50 and the printer section 52. At the same time, the input and output operation control section 532 calculates image processing parameters, set the parameters to the image processing circuit 406, and controls the copying function. The timing control means, for example, designation of an ADF driving timing, a scanner driving timing, a timing of a processing for modifying an image expanded in the memory, and designation of a print start timing, and a next original input start timing, and the like. A secure/release command received from a display control section 534 and related to printer resources or the like is notified to the printer control section 531.

The display control section 534 is composed of a display control software for controlling the operation panel 202 described with respect to FIGS. 4 and 5. The display control section 534 transmits operation information on the operation panel 202 to the overall control section 533, receives various state changes that occur to the apparatus from a machine state management section 535 as information and reflects the received information in the display. Further, the display control section 534 receives information on a processing result and a progress of the processing such as a copying result, the number of copies, and size information from the overall control section 533, and displays the received information in the display. A display method specifically means that an LED on the operation panel 202 is turned on and that a message is displayed on the liquid crystal display 521.

The overall control section 533 always monitors an operation state of the overall apparatus, and executes an exclusive control over resources shared among a plurality of functions such as the scanner section 50 and the printer section 52, a preferential operation for copying and print data printing, a screen switching operation, and the other operations. For example, if a copying screen is being operated or the copying is set preferentially executable, then the overall control section 533 prohibits the print data printing for a predetermined period of time. Conversely, if the print date printing is started, the overall control section 533 switches the screen to now-printing display, and limits execution of the copying operation. Furthermore, the overall control section 533 exercises a time control such as timer monitoring, and appropriately exercises a menu switching control over the display control section 534 and the like depending on situations.

The machine state management section 535 monitors a machine state notified from the scanner control section 530 and the printer control section 531, specifically monitors information on paper clogging, jam release, and opening and closing of a front cover, and notifies the monitored state to the overall control section 533 and the display control section 534, thereby reflecting an error state in display or in a determination as to whether the copying operation is executable.

Further, the machine state management section 535 manages a machine recovery operation when an error is released or a job is finished in accordance with an instruction from the overall control section 533. The recovery operation means herein a preparation operation for the next copying operation such as initialization of a position of an indicator in the scanner section 50 and a warming up operation for a heat roller section.

An apparatus-external apparatus data transfer control section 536 includes the PRNC 410 shown in FIG. 3, and the scanner and printer connected to the apparatus through the LAN, or communication control software for communicating a control signal and image data with a digital copying machine. The PRNC 410 is composed of a network interface card (“NIC”), a buffer memory, and the like.

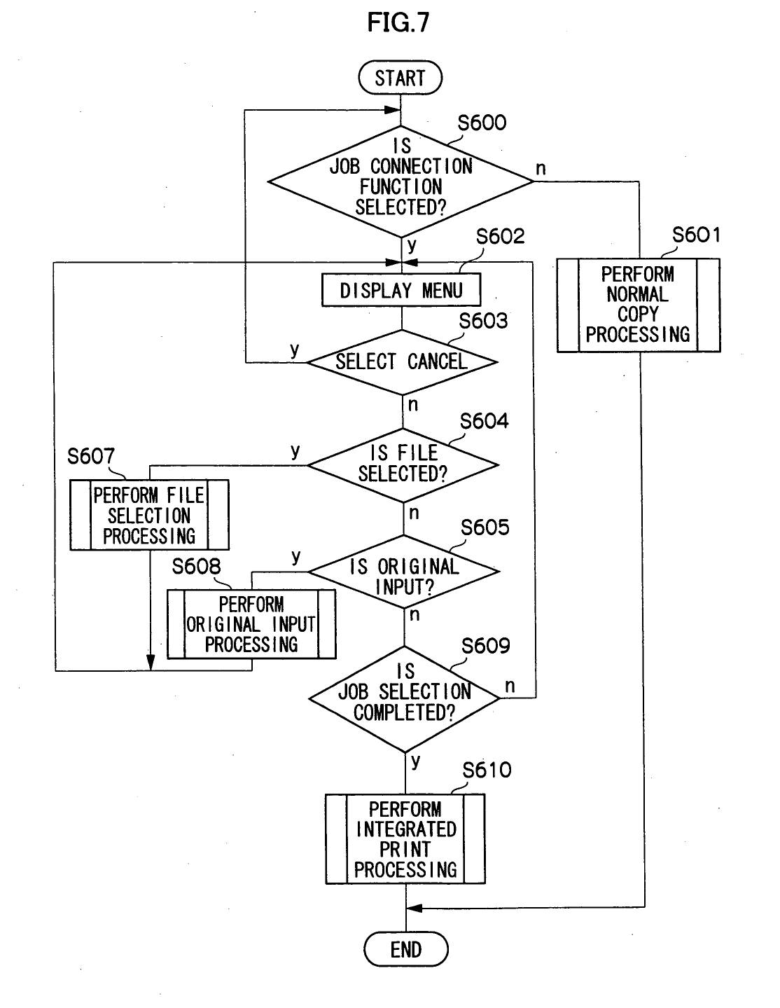

FIG. 7 is a flowchart which shows a flow of overall control related to job connection of the image forming apparatus according to this embodiment.

On an initial menu screen for copying operation (not shown), options of a job-connected print operation or a normal copying operation are displayed. At the beginning of the copying operation, the image forming apparatus determines which option is selected by the user (in a step S600). If the user selects the normal copying operation, the apparatus executes the normal copying processing (in a step S601) and returns to an operation waiting state.

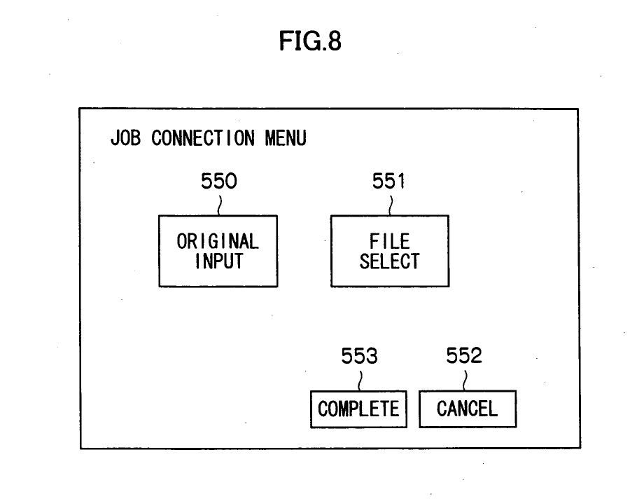

If the user selects the job-connected print operation, the apparatus displays a menu screen shown in FIG. 8 (in a step S602). This menu screen includes an “original input” key (icon) 550 for instructing information on jobs to be connected to be fetched by inputting the original (reading the original), a “file select” key 551 for instructing the information on the jobs to be connected to be fetched from a file already registered as the information on the jobs to be connected, a “cancel” key 552 for invalidating a job connection mode, and a “complete” key 553 for instructing completion of selection of the jobs to be connected.

The image forming apparatus according to this embodiment displays the menu screen shown in FIG. 8, and then determines which of the display keys 550 to 553 is operated (in steps S603 to S605 and S609).

If the “cancel” key 552 is operated, the apparatus returns to the determination processing for determining whether the job connection function is selected (in the step S600).

If the “file select” key 551 is operated, the apparatus executes a file data select processing, to be described later in detail, for selecting one of the file data stored in the memory (in a step S607), and returns to the key operation waiting state while the information connection function is being selected (in the step S602).

If the “original input” key 550 is operated, the apparatus acquires data, mainly reading of the original, to be described later in detail (in a step S608), and returns to the key operation waiting state while the information connection function is being selected (in the step S602).

If the “complete” key 553 is operated, the apparatus executes a selected job-integrated print processing, to be described later in detail (in a step S610), and then returns to an operation waiting state.

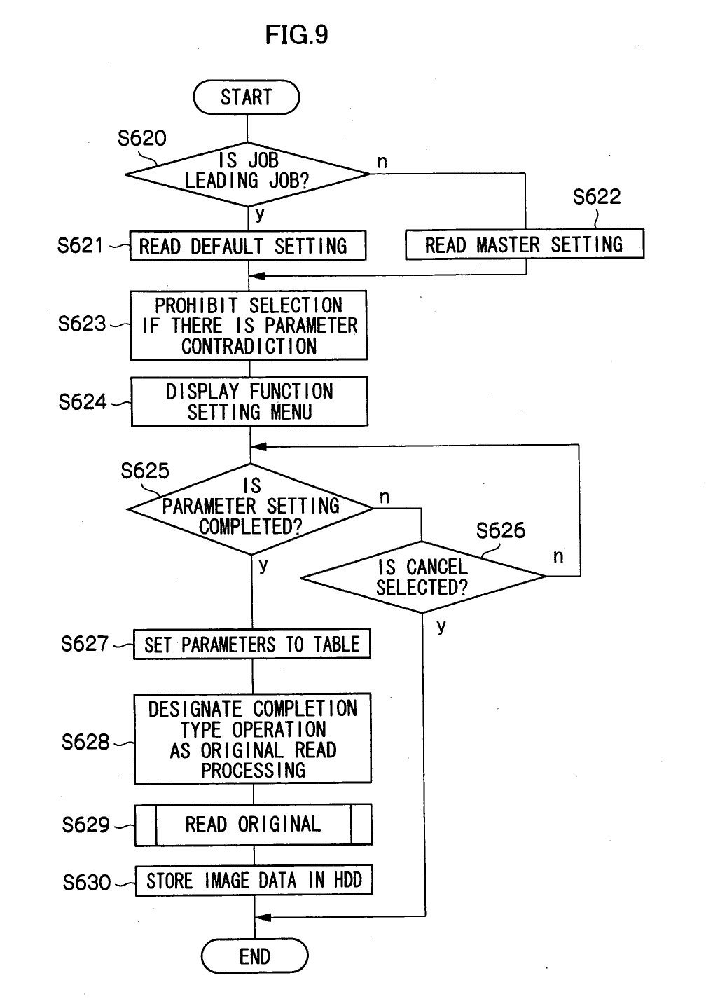

FIG. 9 is a flowchart which shows in detail procedures (in a step S608 of FIG. 7) for controlling job connection by the input of the original when the “original input” key 550 shown in FIG. 7 is operated.

If the processing enters this sub-routine, the image forming apparatus determines whether a job to be set this time is a leading job of jobs to be integrated (in a step S620).

If the job is the leading job, the apparatus reads a default set values for job parameters from the ROM 401, the mass storage device 409, the NVRAM 403, or the like (in a step S621). If the job is not the leading job, the apparatus reads master set values for the job parameters from the mass storage device 409, the NVRAM 403, or DRAM404 or the like (in a step S622). The master set values are, for example, set values for the leading job.

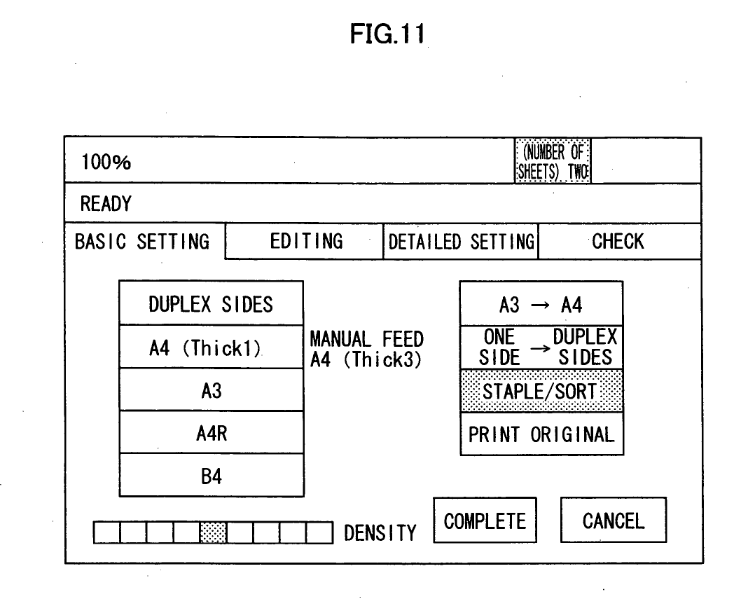

Thereafter, the apparatus compares the parameters with the master set values (basic set values), and prohibits selection of the parameters if the parameters contradict the master set values, and prohibits selection of the functions or the like which contradicts the original size or the like of the originals contained in the cassettes (see FIG. 11 to be described later), displays a job function setting menu screen, and the user sets the parameters (in steps S623 and S624). The job function setting screen includes a “complete” key and a “cancel” key. When the user sets parameters, the apparatus also monitors an operation of the “complete” key and the “cancel” key (in steps S625 and S626).

If the user operates the “cancel” key, the apparatus returns to a main routine (see FIG. 7).

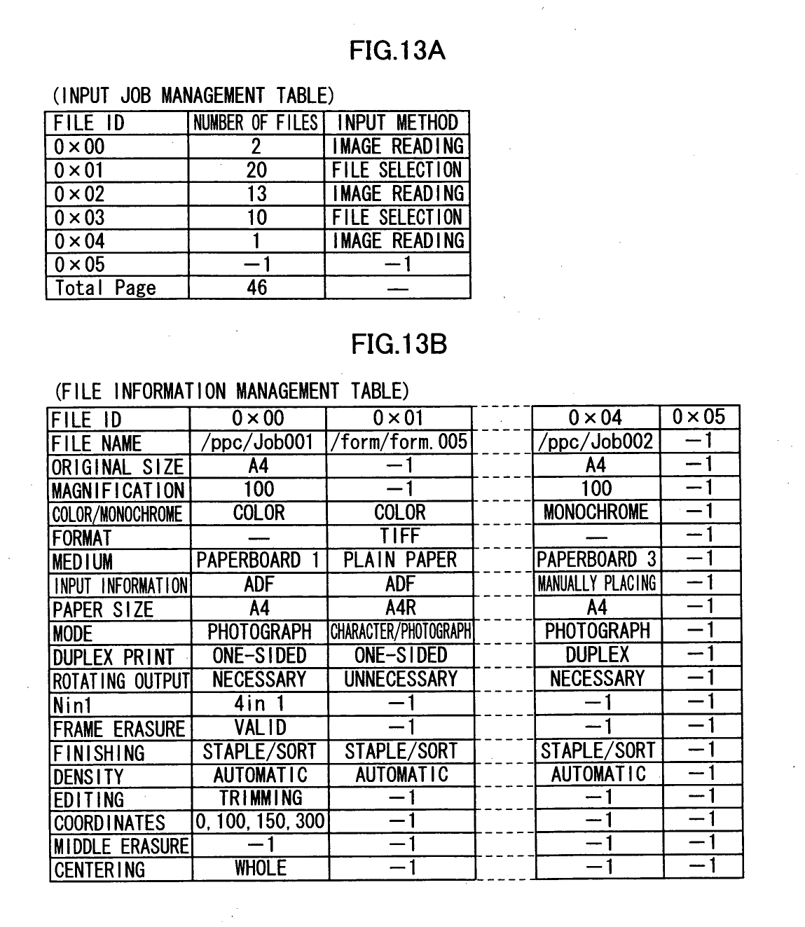

If the user operates the “complete” key, the apparatus stores the parameters or the like thus set in a management table (see FIG. 13 to be described later) (in a step S627). This management table may be provided in the NVRAM 403 or the DRAM 404, or may be provided in the mass storage device 409.

Next, even if a setting of executing an original reading processing and a print processing in parallel is made to the apparatus, then the apparatus designates a so-called completion type operation for always executing only the original reading processing, and executes the original reading processing. When the original reading processing is finished, the apparatus stores obtained image data in the mass storage device 409 (in steps S628 to S630), and backs to the main routine (FIG. 7).

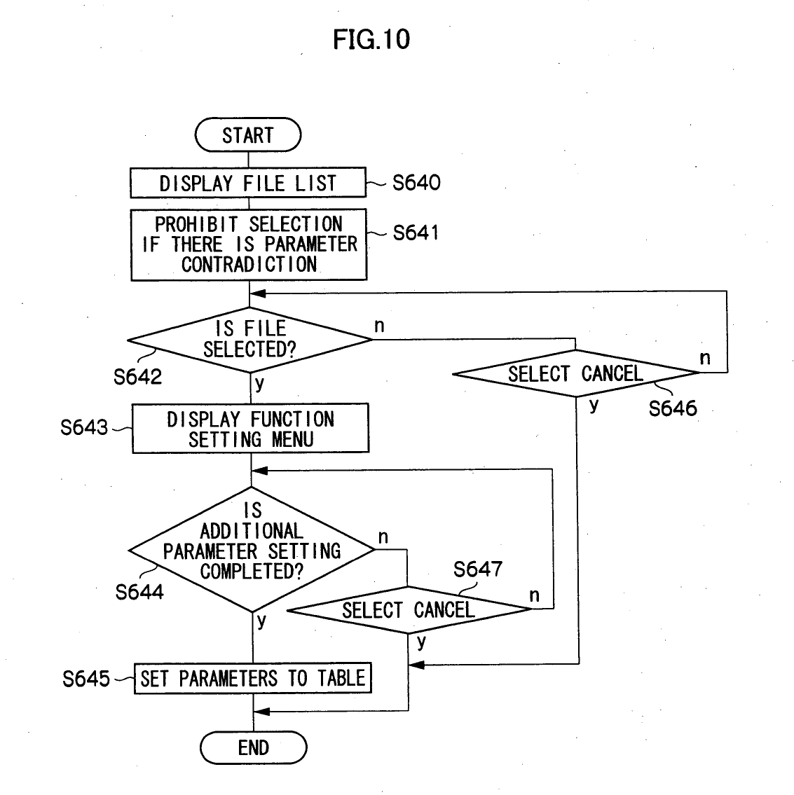

FIG. 10 is a flowchart which shows control procedures for adding a selected file to the job-integrated print data (the step S607 shown in FIG. 7).

First, the apparatus displays a file list retained in the mass storage device 409 or the like on the operation panel 202 (in a step S640). At this time, the apparatus checks parameters for the respective files, and compares the parameters with the master set values (for the leading job, for example). If the parameters have file attributes with which the job cannot be added to the job-integrated print data, the apparatus prohibits selection of the file and displays the result (or does not display the file) (in a step S641). It is noted that the image data files to be included in the jobs are required to be stored in the mass storage device 409 in advance prior to the start of the processing procedures shown in FIG. 7.

On a file list display screen, a cursor that represents that one of the files is a job candidate is displayed, and an execution key for instructing the file to be selected and the like are also displayed. If the user selects one of the files (“Yes” in a step S642), the apparatus displays a job function setting menu screen similar to an ordinary input screen and appropriately including the parameters for the selected file as initial values (in a step S643). At this time, the apparatus may display the parameters for the selected job while deleting a predetermined parameter.

On a function select screen when the file is selected, a setting of an additional parameter, a correction of partial set parameters, and the like can be made. If the user makes the additional parameter setting, the correction of the partial set parameters, or the like, and operates the “complete” key or the like (“Yes” in a step S644), then the apparatus adds the parameters or the like to the management table (in a step S645) and returns to the main routine (FIG. 7)

In the additional parameter setting, for example, an original mode and a paper type during output are designated. The image data used for file selection, for example, is applied as file data from the external apparatus or read for file registration using the scanner section 52 in advance, an insufficient parameter is appropriately set in the additional parameter setting.

On a display screen for the processing procedures shown in FIG. 10, the “cancel” key is appropriately displayed. If the user operates the “cancel key” (“Yes” in a step S646 or S647), then the apparatus stops the file select processing and returns to the main routine (FIG. 7).

FIG. 11 shows one example of the job function setting menu screen displayed in the step S624 shown in FIG. 9 or the step S643 shown in FIG. 10. The job function setting menu screen is composed of a plurality of screens such as a “basic setting” screen, an “editing” screen, a “detailed setting” screen, and a “check” screen. On the “basic setting” screen among these screens, the parameters for main items can be set.

In FIG. 11, halftone dot portions correspond to the items which are prohibited from being set for subsequent input jobs. For example, information of the number of sheets is prohibited from being changed when a sorting function is set. A staple/sort condition is an item related to overall output jobs. Therefore once the staple/sort condition is selected, the item cannot be selected/changed in the subsequent jobs.

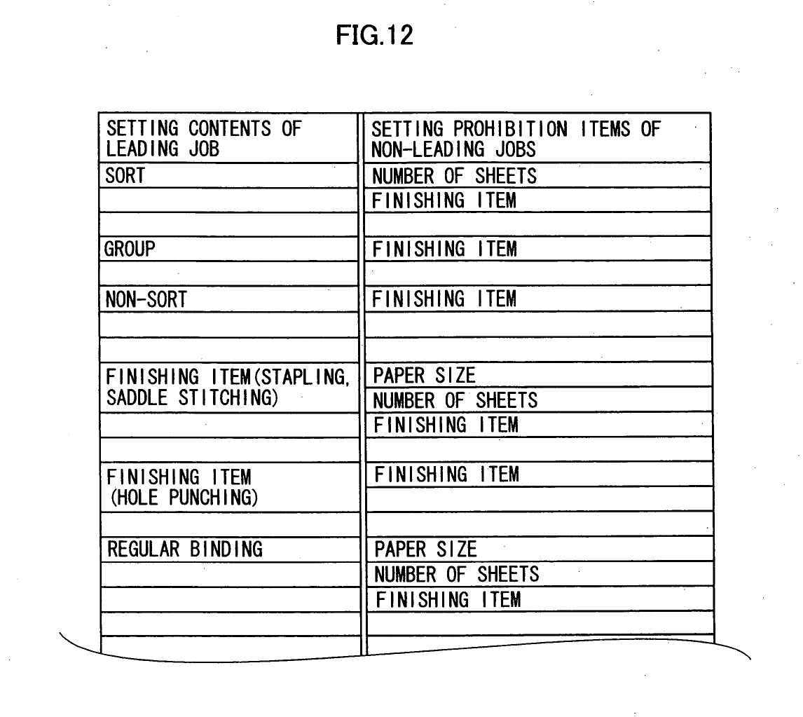

FIG. 12 is an explanatory view for functions restricted in the subsequent jobs in accordance with contents of the setting of the master job (e.g., the leading job). Such function restriction information is stored in the ROM 401, the NVRAM 403, or the like.

The example of FIG. 12 indicates that if the sort function is selected in the leading job, the number of sheets and the finishing function cannot be changed in subsequent jobs. Further, a group function and a non-sort function for outputting the number of sheets already set per page are not influenced by the change of the number of sheets. Due to this, the number of sheets is permitted to be changed for the group function and the non-sort function. Further, the example of FIG. 12 indicates that once a saddle stitching function or a stapling function among the finishing functions is set for the leading job, the saddle stitching or stapling function cannot be changed at all for subsequent jobs. This is because if the function related to overall integrated output is changed afterwards, the setting contents before change may possibly contradict those after change. For example, an case in which the change or addition of the setting cannot be made corresponds to B4-size data if the stapling function is selected in input conditions for inputting data having a width of A4. In addition, if a hole punching function is selected, the finishing functions cannot be changed during setting of the subsequent jobs. However, for the hole punching function that can be executed irrespective of the size or the number of sheets, the size and the number of sheets can be changed.

Alternatively, if the function is set for the subsequent jobs, the parameters for the leading job may be changed although this differs from the present embodiment.

Referring to such function control information, setting-prohibited items are displayed while discriminating these items from the other items (e.g., the setting-prohibited items are displayed by halftone dots) when the job function setting menu screen shown in FIG. 11 is displayed. By doing so, an erroneous operation by the user can be prevented.

Further, the function restriction information shown in FIG. 12 is also referred to in the connected-job integrated print processing to be described later.

FIG. 13 shows one example of the management table for integrally managing the data on the connected jobs obtained in the procedures shown in FIG. 7. In FIG. 13, “−” denotes a default and “−1” denotes non-setting.

The integrated job data is subjected to integrated management by an input job management table shown in FIG. 13A and a file information management table shown in FIG. 13B.

The input job management table stores the total number of pages for each job and a generation source (whether image input or file selection) while making them correspond to a file ID (a job ID) related to the job. The example of FIG. 13A indicates that five jobs (image input jobs and file image data) are integrated and output. Arrangement of file IDs represent an output order. Alternatively, output order data may be input when the job data is input, and the jobs may be rearranged in the output order when connection completion is indicated.

Further, by fixing a storage capacity allocated to the input job management table, an upper limit may be set for the number of possible connectable jobs. Further, an upper limit may not be set for the number of jobs as long as the storage capacity includes an empty capacity.

The file information management table stores detailed parameters for each job corresponding to the file ID stored in the input job management table. A file name (or a file ID) indicates a path to the file to be stored (image data). That is, a file name (or a file ID) indicates correspondence to the image data stored in the mass storage device 409. As for a format, format information on a designated file is indicated.

As shown in FIG. 13B, items (parameters) that can be set differently according to jobs include “original size”, “magnification”, “color or monochrome”, “format”, “print medium”, “input method”, “paper size”, “original mode”, “duplex or one-sided”, “whether rotating output is necessary or unnecessary”, “number of originals arranged on one surface (Nin1)”, “whether frame erasure is valid or invalid”, “finishing”, “density”, “editing”, “coordinates”, “whether center erasure is necessary or unnecessary”, “centering” and the like.

In FIG. 13A, “number of files” is an item that can be set differently according to jobs. “number of files” is stored not in the file information management table but in the input job management table. This is because this item serves as a parameter for determining whether the finishing function, to be described later, is executable.

The input job management table and the file information management table are invalidated, for example, when a connected-job integrated print processing, to be described later, is finished.

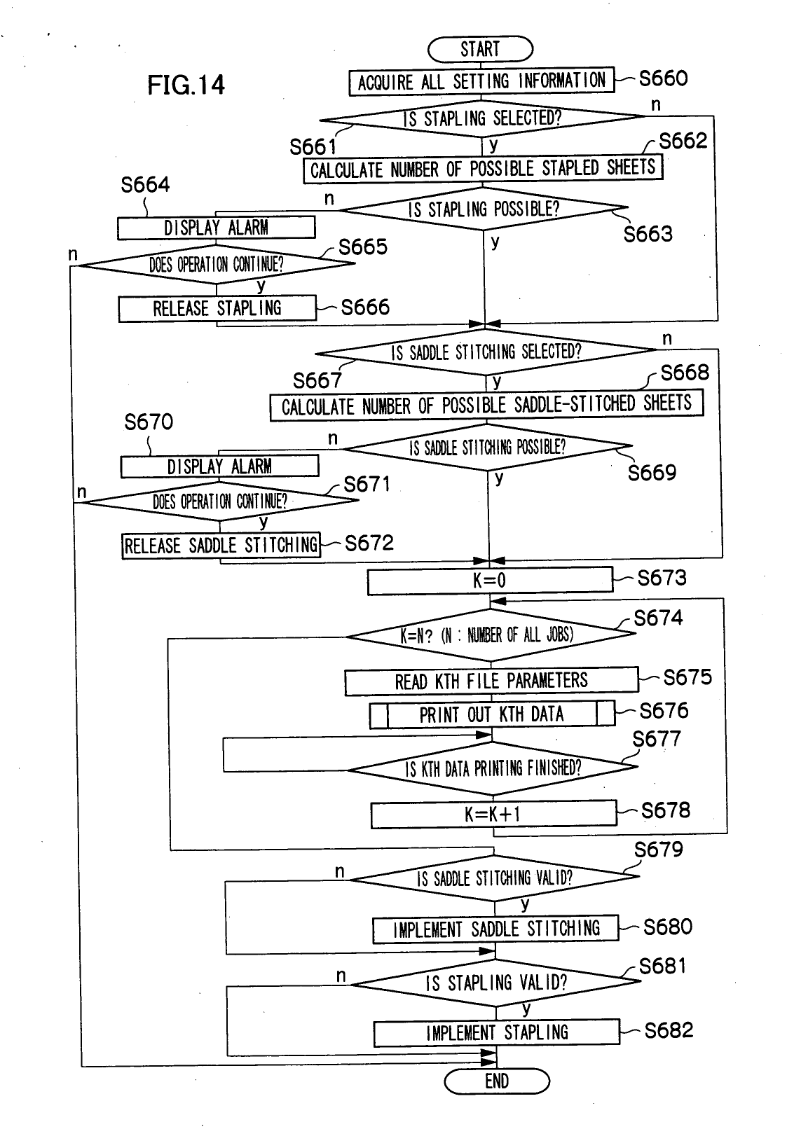

FIG. 14 is a flow chart which shows processing procedures for the connected-job integrated print processing (the step S610 shown in FIG. 7).

First, the apparatus acquires all setting information on connected jobs from the management tables shown in FIGS. 13A and 13B (in a step S660).

If a certain finishing function is selected (in steps S661 and S667), the apparatus calculates the total number of sheets used to determine whether the finishing function is executable (in steps S662 and S668). A method for calculating the number of sheets will be described later. If the total number of sheets exceeds an upper limit (“No” in steps S663 and S669), then the apparatus displays an alarm (in steps S664 and S670) and inquires the user whether the finishing function can be released (in steps S665 and S671). In the example of FIG. 14, a stapling function and saddle stitching function are shown as the finishing functions.

If the user instructs cancellation of the processing, the apparatus finishes the processing. If the user instructs continuation of the processing, the apparatus invalidates the finishing function and continuously carries out the processing (in steps S666 and S672).

Thereafter, the apparatus sets a parameter K at an initial value of zero (in a step S673), the apparatus sequentially reads parameters for and image data on a K^{th} (where K=0 to N−1) print file (in steps S674 and S675), and executes a printout processing (in a step S676) while confirming that the print files for all jobs are not completely printed (in a step S674). When the printout processing is finished, the apparatus executes the printout processing to (K+1)^{th} data similarly (in a step S678).

When the printout processings are completed for all pieces of image data, the apparatus checks whether the finishing function is valid (in steps S679 and S681). If the finishing function is valid, the apparatus executes the function (in steps S680 and S682).

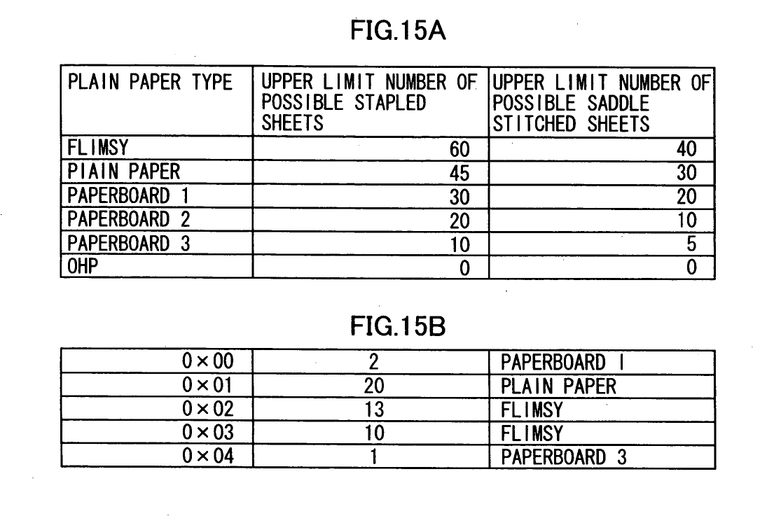

FIGS. 15A and 15B are explanatory views for the method for calculating the total number of sheets for the finishing function in the step S662 or S668 shown in FIG. 14.

FIG. 15A shows limited numbers of sheets for the respective finishing functions (the stapling function and the saddle stitching function in FIG. 15A) in an ideal case in which all the jobs are the same in original type. FIG. 15B shows the number of prints and the original type for each job of certain connected jobs.

In the example shown in FIGS. 15A and 15B, for the connected jobs using a single original type, the limited number of sheets is 45 for plain paper, 30 for paperboard 1, 20 for paperboard 2, 10 for paperboard 3, and 60 for flimsy. For the paper types other than the plain paper type, the number of sheets is converted into the number of sheets of plain paper when calculating the total number of sheets for the connected jobs. The conversion maybe performed for the other print medium.

Consequently, if the stapling function is selected in the example of FIG. 15B, then the calculated total number of sheets (total number of sheets obtained by converting the number of sheets into that of plain paper) is 44.75 smaller than an actual total number of 46 as expressed by Equation (1), and smaller than the limited number of sheets of plain paper.
2×(45/30)+20+13×(45/60)+10×(45/60)+1×(45/10)=44.75 (1)

According to this embodiment, one user intended job is divided into a plurality of types of input jobs according to the conditions, print conditions during output can be designated, and the integrated print processing can be carried out during output. Therefore, for one job intended by the user for which various originals are mixed, the throughput of the apparatus can be considerably reduced, and realize high-quality output.

Namely, when a document for which different original types (photograph and character) and different original sizes are mixed is to be input and output, inputs according to the types and attributes can be executed as a series of jobs (connected jobs). At that time, print mediums and print formats can be individually designated for the respective jobs. Besides, by enabling integrated output of the jobs as one job, the throughput of the apparatus for the high-quality printout for one job intended by the user for which various originals are mixed can be considerably, advantageously reduced.

More specifically, for a document for which various original types such as a photographic original, a character original, a map original, a one-sided original, a duplex original, an A4-size original, an A3-size original, as well as a film photo and a paperboard original which are too large to be fed to the ADF, the job can be divided into a plurality of jobs according to types and attributes, and can be input. At that time, by enabling designating print output paper such as paperboard or flimsy, output formats such as one-sided output/duplex output and rotating output, the image processing for characters or print, the output finishing processing such as stapling, the throughput of the apparatus for the high-quality printout for the job for which various originals are mixed can be considerably, advantageously reduced.

Furthermore, by prohibiting the change of the setting of the setting conditions contradicting the output conditions designated for the leading input job for the subsequent input jobs, and prohibiting the setting contradicting realization of the setting conditions, the number of failures caused by setting errors can be advantageously reduced.

By prohibiting the change of the settings related to the all jobs such as the output finishing processing set for the leading input job in the subsequent jobs, and by prohibiting the original type and the output mode that inhibit the setting conditions, the number of failures caused by setting errors can be advantageously reduced.

By prohibiting the change of the setting of the finishing function such as the stapling or regular binding set for the leading input job in the subsequent jobs, and prohibiting the settings of the original type, the paper size, and the output processing such as Nin1 or rotation that may possibly inhibit the setting conditions, the number of failures caused by setting errors can be advantageously reduced.

In this embodiment, the respective jobs are input in the printout order. Alternatively, after inputting the respective jobs, a printout order of each job may be input. In this alternative, the job (master job) that gives restrictions to the setting items for the other jobs may be the leading input job or the first printed-out job.

In this embodiment, the case of applying the present invention to the color image forming apparatus has been described. The present invention can be also applied to a monochrome image forming apparatus. The image forming apparatus according to the present invention can be applied to a copy-dedicated apparatus, and a system having an image scanner and a printer connected to the PC. An arbitrary application target can be used as long as the target conforms to the technical concept of the present invention.

Moreover, in the embodiment, the image forming apparatus including one printer section is described. Alternatively, the number of printers may be two or more. If the finishing item such as stapling is not set, output processings of a plurality of jobs (divided jobs) may be carried out in parallel.

Further, in this embodiment, when each job to be connected are selected, the case in which both the image read input and the file selection are allowed has been described. However, it may be the case in which the only image read input is recognized as well as the only file selection is recognized.

Furthermore, in this embodiment, the case in which the apparatus fixedly holds the setting items for the other jobs restricted by those for the master job has been described. In addition, the user may arbitrarily set the items.

In this embodiment, the case in which the management tables related to the connected jobs are automatically invalidated when the integrated print processings are finished. Alternatively, the management tables may be invalidated only by user's operation.

In this embodiment, the case in which the apparatus determines whether the number of converted prints exceeds the limited number for the selected finishing item in the integrated print processing phase has been described. Alternatively, the apparatus may make this determination whenever the input of the parameters for each job is finished.

Further, when the connected jobs are input, the finishing items of the finishing functions may be excluded from the setting items for the respective jobs, and the finishing items of the finishing functions may be input before starting the input of each job or after finishing the input of all jobs. For the other setting items, the common settings as stated above may be permitted.

For the settings of the parameters for the subsequent jobs, the settings of the parameters for already-set jobs may be permitted to be copied by the user (note, however, that the image reading and the file selection should be set for each job). For example, if three jobs are connected, and only a second job differs from the other jobs, this modification is effective.

Moreover, in this embodiment, the case in which the integrated print processing is executed soon after the settings of the parameters for all the jobs to be connected and the like are finished has been described. Alternatively, when the settings of the parameters for all the jobs to be connected and the like are finished, a check screen (e.g., a screen on which the contents of the management tables shown in FIGS. 13A and 13B are converted into formats understandable to the user) may be displayed, and the integrated print processing may be started after a print start instruction is given on this screen. Further, the user may move to the correction processing for correcting the parameters for partial jobs, or the job deletion, addition, and moving processings from this check screen.

1. An image forming apparatus including at least one image input section that fetches image data on an original, and at least one image output section printing out the image data, the apparatus comprising:
job information fetching means for fetching set values as a plurality of different jobs whenever input and output conditions for the image data differ, and for connecting the plurality of different jobs as a series of jobs; and
printout control means for controlling the image output section to execute a series of printout processings according to the output conditions for the respective plurality of jobs connected as the series of jobs.

2. The image forming apparatus according to claim 1, wherein
the job information fetching means causes the image input section to fetch the image data according to the input conditions for the respective jobs connected as the series of jobs whenever set values of the input and the output conditions for the respective jobs are fetched, and
the printout control means controls the image output section to execute the series of printout processings while switching the output conditions, including an output medium and an output image processing, according to the set values of the output conditions for the respective plurality of jobs connected as the series of jobs.

3. The image forming apparatus according to claim 1, wherein
the input and the output conditions for the different jobs fetched by the job information fetching means include at least items of an original mode setting according to an original type of the input original and of an original input type such as a manually placed original or an automatic original reader original, items of an original size and of an input processing method such as enlargement or reduction, items of a print medium, items of edit output such as rotating output, a one-sided output or a duplex output, or the number of originals arranged on one surface, and of an output image processing according to the input conditions.

4. The image forming apparatus according to claim 1, wherein
the image input section reads the original and acquires the image data.

5. The image forming apparatus according to claim 1, wherein
the image input section acquires the image data by selecting one or a plurality of stored image data files.

6. An image forming apparatus including at least one image input section that fetches image data on an original, and at least one image output section printing out the image data, the apparatus comprising:
job information fetching means for fetching set values as a plurality of different jobs whenever input and output conditions for the image data differ, and for connecting the plurality of different jobs as a series of jobs;
inter-job output condition monitoring means for limiting, among the respective plurality of jobs connected as the series of jobs, the set values of the other jobs contradicting set values of the output conditions for the standard job; and
printout control means for controlling the image output section to execute a series of printout processings according to the output conditions for the respective plurality of jobs connected as the series of jobs.

7. The image forming apparatus according to claim 6, wherein
the printout control means controls the image output section to execute the series of printout processings while switching the output conditions, including an output medium and an output image processing, according to the set value of the output conditions for the respective plurality of jobs connected as the series of jobs.

8. The image forming apparatus according to claim 6, wherein
the job set as the standard job of the inter-job output condition monitoring means is the job that is processed first in the series of printout processings.

9. The image forming apparatus according to claim 6, wherein
the inter-job output condition monitoring means prohibits the job information fetching means from fetching contradictory set values.

10. The image forming apparatus according to claim 6, wherein
the inter-job output condition monitoring means prohibits the image output section from carrying out one of the series of printout processing according to contradictory set values.

11. The image forming apparatus according to claim 6, wherein
the output conditions fetched by the job information fetching means include a print paper type, a duplex output or a one-sided output, an output of the number of originals arranged on one surface, whether a rotating output is carried out, and a finishing function such as stapling or regular binding, and
the inter-job output condition monitoring means prohibits, among the output conditions, the output conditions contradicting the set values of the same or other output conditions for the standard job.

12. The image forming apparatus according to claim 6, wherein
the printout control means converts the number of printed sheets set for each of the plurality of jobs into the number of sheets assuming that a standard print paper type is applied to the each job, irrespective of the print paper type set for the each job, determines whether a predetermined finishing function is executable, and then controls the image output section to executes the printout processings.
